(19) United States
(12) Patent Application Publication
(10) Pub. No.: US 2008/0186583 A1
(43) Pub. Date: Aug. 7, 2008

(54) OPTICAL DEVICE AND METHOD OF MANUFACTURING THE SAME

(75) Inventor: Yoshiki TAKAYAMA, Shiga (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/936,906

(22) Filed: Nov. 8, 2007

(30) Foreign Application Priority Data
Feb. 6, 2007 (JP) 2007-026210

(51) Int. Cl. G02B 27/00; B05D 5/06

(52) U.S. Cl. 359/601; 156/280; 156/60

(57) ABSTRACT

In an optical device in accordance with the present invention, a transparent member (5) covering a light receiving portion (2) on a top surface of an optical element (3) is composed of a base material (8) secured on the top surface of the optical element (3), and a resin portion (9) forming a fillet between each outer side surface of the base material (8) and the top surface of the optical element (3). The base material (8) and the resin portion (9) are optically integrated together. Each outer peripheral surface of the transparent member (S) constitutes an inclined surface (7).

### FIELD OF THE INVENTION

The present invention relates to an optical device and a method of manufacturing the optical device, and in particular, to an optical device that can prevent unwanted incident light and reflected light from entering a light receiving portion, and a method of manufacturing the optical device.

### BACKGROUND OF THE INVENTION

In recent years, electronic apparatuses have been increasingly miniaturized, and there has also been the need to miniaturize optical devices used in electronic apparatuses. Thus, while in conventional optical devices, an optical element is housed in a recessed package (container) having an opening sealed by protective glass (hereinafter referred to as a transparent member), in a newly developed optical device, the transparent member is secured directly on the optical element. The newly developed optical device thus has a reduced size and a reduced thickness.

However, when the transparent member is secured directly on the optical element, the reduced distance between each end surface (outer peripheral surface) of the transparent member and a light receiving portion of the optical element allows unwanted incident light to easily enter the light receiving portion through the end surface of the transparent member. This may result in unacceptable images such as flares or ghosts.

To prevent the possible unwanted incident light, a proposal has been made to increase the size of the transparent member so as to locate the end surfaces away from the light receiving portion of the optical element. Other proposals have been made to form a light blocking layer in the end surface of the transparent member and to form a light blocking layer not only in the end surfaces but also in the outer peripheral portions of a top surface and a bottom surface of the transparent member. Moreover, a proposal has been made to tilt the end surfaces to prevent light reflected inside the light blocking layer from entering the light receiving portion (for example, Japanese Patent Laid-Open No. 2002-261260).

However, the scheme of increasing the size of the transparent member forces package size to be increased, making it difficult to miniaturize the device. A light blocking material is indispensable for the scheme of forming the light blocking layer, which further requires dedicated steps such as deposition, electrodeposition coating, photolithography and a thin film process, and coating. If the light blocking layer is formed by coating the light blocking material (for example, a light blocking resin), a coating space is required, forcing an increase in package size. This makes it difficult to miniaturize the device. All these factors lead to an increase in costs.

### DISCLOSURE OF THE INVENTION

In view of these problems, an object of the present invention is to provide a small-sized optical device having a transparent member secured directly on an optical element but which can prevent unwanted incident light or reflected light from entering a light receiving portion through end surfaces of the transparent member.

To accomplish this object, an optical device in accordance with the present invention having an optical element with a light receiving portion formed on a top surface thereof and a transparent member covering the light receiving portion, the transparent member including a base material secured to the top surface of the optical element and a resin portion forming a filet between outer side surfaces of the base material and the top surface of the optical element.

The transparent member has the base material and the resin portion optically integrated together. Each of the outer peripheral surfaces of the transparent member is an upward inclined surface formed so that the distance between the outer peripheral surface and the light receiving portion is longer at a position in the transparent member closer to the top surface of the optical element. This increases the distance between the transparent member and the light receiving portion, inhibiting unwanted incident light from the outside of the inclined surface from reaching the light receiving portion. This further inhibits incident light from the inside of the inclined surface from reaching the light receiving portion as reflected light.

Furthermore, since the outer peripheral surface of the transparent member is the inclined surface, it is unnecessary to take into account, for example, the possible interference between the transparent member and a capillary during wire bonding. This makes it possible to miniaturize a package. Moreover, the thus shaped transparent member is not composed of a single member but of the base material and the resin portion Thus, outer side surfaces of the base material itself may be surfaces perpendicular to the top and bottom surfaces. The resin portion may be formed simultaneously with the step of securing the base material on the optical element. This results in a simple process.

An adhesive used to secure the base material on the optical element and the resin portion preferably include the same transparent resin material. The resin portion is preferably covered with a light blocking resin. The optical element has only to have electrode portions formed on at least one of the top and bottom surfaces. The optical element itself has such a general-purpose form, enabling diversified packaging and mounting.

For example, the optical element may have the electrode portions formed at appropriate positions on a part of the top surface which is not covered with the transparent member, and may be connected, at the electrode portions, to internal terminals of conductors via metal wires and sealed with a sealing resin so as to have an opening on the transparent member. The sealing resin preferably blocks light.

Furthermore, the optical element may have the electrode portions formed at appropriate positions on a part of the top surface which is not covered with the transparent member, and may be connected, at the electrode portions, directly to electrodes formed on a circuit board opposite the respective electrode portions, the circuit board having an opening corresponding to the transparent member.

Furthermore, the optical element may have projecting electrode portions formed at appropriate positions on a part of the top surface which is covered with the transparent member, the transparent member has wires formed on a base material thereof and having electrodes arranged opposite the electrode portions, and the electrode portions of the optical element are connected directly to the electrodes on the transparent member.

A method of manufacturing an optical device in accordance with the present invention includes a step of coating a first transparent resin material on a central portion of a transparent member area of a top surface of an optical element, a step of coating a second transparent resin material on a peripheral portion of a base material, and a step of mounting and securing the base material on the top surface of the optical element using the first and second transparent resin materials, and forming a fillet including the second transparent resin material between the top surface of the optical element and each outer side surface of the base material.

Alternatively, a method of manufacturing an optical device in accordance with the present invention includes a step of coating a first transparent resin material on a central portion of a transparent member area of a top surface of an optical element, a step of mounting and securing a base material on the top surface of the optical element using the first transparent resin material, and a step of coating a second transparent resin material on outer side surfaces of the base material secured on the top surface of the optical element to form a fillet including the second transparent resin material between the top surface of the optical element and each of the outer side surfaces of the base material.

Alternatively, a method of manufacturing an optical device in accordance with the present invention includes a step of coating a first transparent resin material and a second transparent resin material on a central portion and a peripheral portion of a transparent member area of a top surface of an optical element, and a step of mounting and securing a base material on the top surface of the optical element using the first and second transparent resin materials, and forming a fillet including the second transparent resin material between the top surface of the optical element and each outer side surface of the base material.

Alternatively, a method of manufacturing an optical device in accordance with the present invention includes a step of coating a transparent resin material on a central portion of a transparent member area of a top surface of an optical element, and a step of mounting and securing a base material on the top surface of the optical element using the transparent resin materials, and forming a fillet including the transparent resin material between the top surface of the optical element and each outer side surface of the base material.

### BRIEF DESCRIPTION OF THE DRAWINGS

FIGS. 1A and 1B are diagrams showing an optical device in accordance with a first embodiment of the present invention;

FIGS. 2A, 2B, and 2C are diagrams showing an incident light and reflected light inhibiting effect of a transparent member of the optical device in FIG. 1;

FIG. 3 is a diagram showing that a light blocking resin film is provided on the transparent member of the optical device in FIG. 1;

FIGS. 4A, 4B, and 4C are diagrams showing a first example of a method of manufacturing the optical device in FIG. 1;

FIGS. 5A, 5B, and 5C are diagrams showing a second example of a method of manufacturing the optical device in FIG. 1;

FIGS. 6A, 6B, and 6C are diagrams showing a third example of a method of manufacturing the optical device in FIG. 1;

FIGS. 7A and 7B are diagrams showing a first example in which the optical device in FIG. 1 is packaged;

FIGS. 8A and 8B are diagrams showing a second example in which the optical device in FIG. 1 is packaged;

FIGS. 9A and 9B are diagrams showing a third example in which the optical device in FIG. 1 is packaged;

FIGS. 10A and 10B are diagrams showing an optical device in accordance with a second embodiment of the present invention;

FIGS. 11A and 11B are diagrams showing an optical device in accordance with a third embodiment of the present invention;

FIGS. 12A and 12B are diagrams showing an optical device in accordance with a fourth embodiment of the present invention;

FIGS. 13A and 13B are diagrams showing a first example in which the optical device in FIG. 12 is packaged; and

FIGS. 14A and 14B are diagrams showing a second example in which the optical device in FIG. 12 is packaged.

### DESCRIPTION OF THE EMBODIMENTS

Embodiments of the present invention will be described below with reference to the drawings.

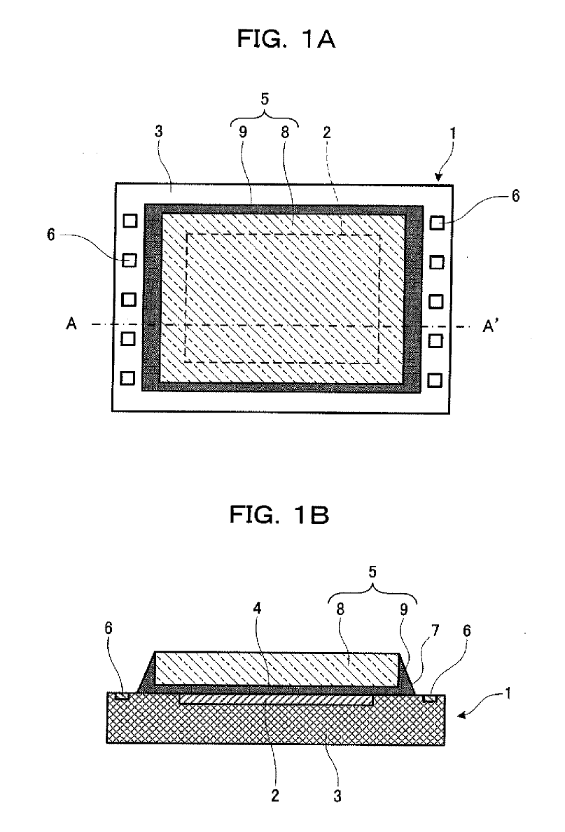

FIG. 1A is a plan view of an optical device in accordance with a first embodiment of the present invention. FIG. 1B is a sectional view of the optical device taken along line A-A′ in FIG. 1A.

In FIGS. 1A and 1B, an optical device 1 has an optical element 3 having a light receiving portion 2 formed on a top surface thereof and a transparent member 5 covering the light receiving portion 2 and secured on a top surface of the optical element 3 using a resin adhesive 4. Electrode portions 6 electrically connected to the light receiving portion 2 are formed in a peripheral portion of the top surface of the optical element 3 which is not covered with the transparent member 5. The optical element 3 is an image sensor or the like. Any transparent resin material, that is, one of an acrylic resin, an epoxy resin, a silicon resin, and the like, is used as the resin adhesive 4.

The transparent member 5 is shaped like a generally rectangular plate. Both a top surface and a bottom surface of the transparent member 5 are sized to cover the light receiving portion 2. Four outer peripheral surfaces of the transparent member 5 are each formed as an upward inclined surface 7 formed so that the distance between the outer peripheral surface and the light receiving portion 2 is longer at a position in the transparent member 5 closer to the top surface of the optical element 3. In other words, the transparent member 5 is tapered so as to be thinner from the bottom surface to top surface thereof.

Specifically, the transparent member 5 is composed of a rectangular plate-shaped base material 8 secured to the top surface of the optical element 3 and a resin portion 9 forming a fillet between the four outer side surfaces of the base material 8 and the top surface of the optical element 3. The resin portion 9 has the inclined surface 7. Plate-like glass (cover glass) is generally used as the base material 8. However, the base material 8 may be any transparent material (solid) pre-formed to have a desired shape by means of cutting or molding. Any transparent resin material, that is, one of an acrylic resin, an epoxy resin, a silicon resin, and the like, is used as the resin portion 9.

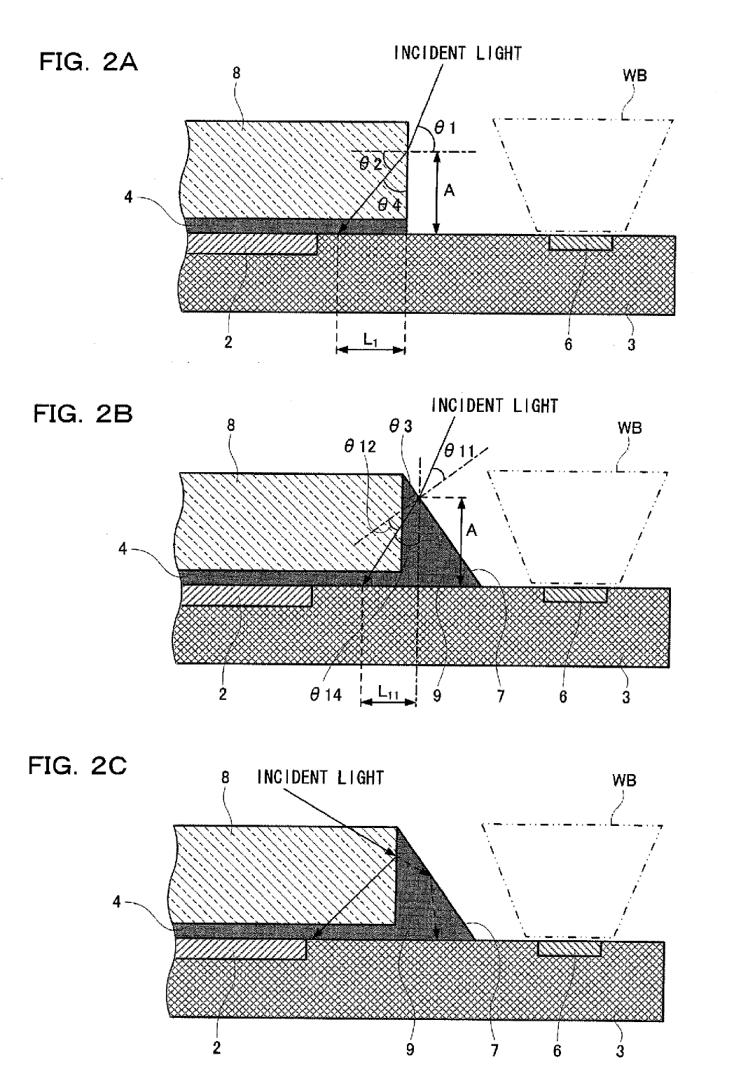

In the transparent member 5, the base material 8 and the resin portion 9 are optically integrated together. The inclined surface 7 of the resin portion 9 exerts the same effects as those of the inclined outer peripheral surface of a transparent member made of a single material. This will be described with reference to FIG. 2. Reference character WB in the figure denotes a capillary for wire bonding.

First, unwanted incident light from the outside of the outer peripheral surface of the transparent member 5 is inhibited from reaching the light receiving portion 2.

As shown in FIG. 2A, it is assumed that if only the base material 8 is present and when incident light (called an outside beam) enters one of the outer side surfaces (perpendicular to the top surface of the optical element 3) of the base material 8 at a point at a distance A from the top surface of the optical element 3 and at an angle θ₁ to the normal of each of the outer side surfaces, the light advances through the base material 8 at an angle θ₂ and reaches a point at a distance L₁ on the top surface of the optical element 3. Then, the distance L₁ is expressed by A tan θ₄.

In contrast, as shown in FIG. 2B, if the resin portion 9 (fillet) is present and when the outside beam traveling in the same direction as described above enters the inclined surface 7 of the resin portion 9 with a fillet angle θ₃ at the point at the distance A from the top surface of the optical element 3, the beam inclines at an angle θ₁₁ (<θ₁) to the normal of the inclined surface 7, travels through the integrated resin portion 9 and base material 8 (that is, the transparent member 5) at an angle θ₁₂, and reaches the top surface of the optical element 3 at the point at the distance L₁₁. The distance L₁₁ is expressed by A tan θ₁₄. Since light has a fixed refractive index (air/glass), the relationship θ₁/θ₂=θ₁₁/θ₁₂ is established.

As seen in FIGS. 2A and 2B, when θ₂+θ₄=90 and θ₁₂+θ₁₄=θ₃, θ₄>θ₁₄ and L₁>L₁₁. That is, the point where the light reaches the top surface of the optical element 3 is farther from the light receiving portion 2 when the resin portion 9 (fillet) is present. This inhibits the entry of light into the light receiving portion 2.

Second, incident light from the inside of the outer peripheral surface of the transparent member 5 is inhibited from reaching the light receiving portion 2 as reflected light. As shown in FIG. 2C, when only the base material 8 is present, incident light (hereinafter referred to as an inside beam) is reflected by the outer side surface (end surface) and travels along an optical path shown by a solid line. In contrast, if the resin portion 9 (fillet) is present, the light travels along an optical path on which the light is reflected by the inclined surface 7 as shown by a dashed line. This inhibits the entry of light into the light receiving portion 2.

The same transparent resin material is preferably used for the resin adhesive 4, used to secure the base material 8 on the optical element 3, and for the resin portion 9, forming the fillet. When both the resin adhesive 4 and the resin portion 9 have the same adhesion properties and optical properties, device properties are stabilized, facilitating manufacture.

As described above, since each of the four outer peripheral surfaces of the transparent member 5 entirely constitutes the inclined surface 7, the unwanted incident light and reflected light are effectively inhibited from reaching the light receiving portion. However, the inclined surface may be limited to the outer peripheral surface except for portions entered by a beam at smaller incident angles and portions such as corners which are very distant from effective pixels and are thus not affected by end surface reflection.

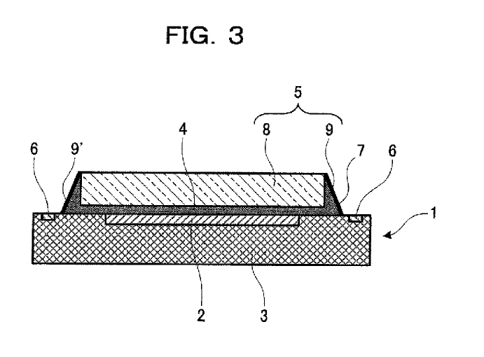

All or at least a part (having a smaller incident angle) of each outer peripheral surface of the transparent member 5 may be subjected to a light blocking process such as coating of a light blocking resin. This improves the effect of inhibiting the unwanted incident light and reflected light. FIG. 3 shows that a light blocking resin film 9′ is uniformly provided all over the outer peripheral surface of the transparent member 5, that is, all over the inclined surface 7 of the resin portion 9. An example of a material for the light blocking resin film 9′ is one of a thermal setting acrylic resin, a thermal setting epoxy resin, a thermal setting silicon resin, and the like to which carbon is added to improve the light blocking function. The coating method may be one of potting, ink jet, and a printing scheme. The “at least a part” of the outer peripheral surface may be one of a part of the outer peripheral surface in a thickness direction, a part of the outer peripheral surface in a circumferential direction, a part in which the inclined surface is not formed, and the like.

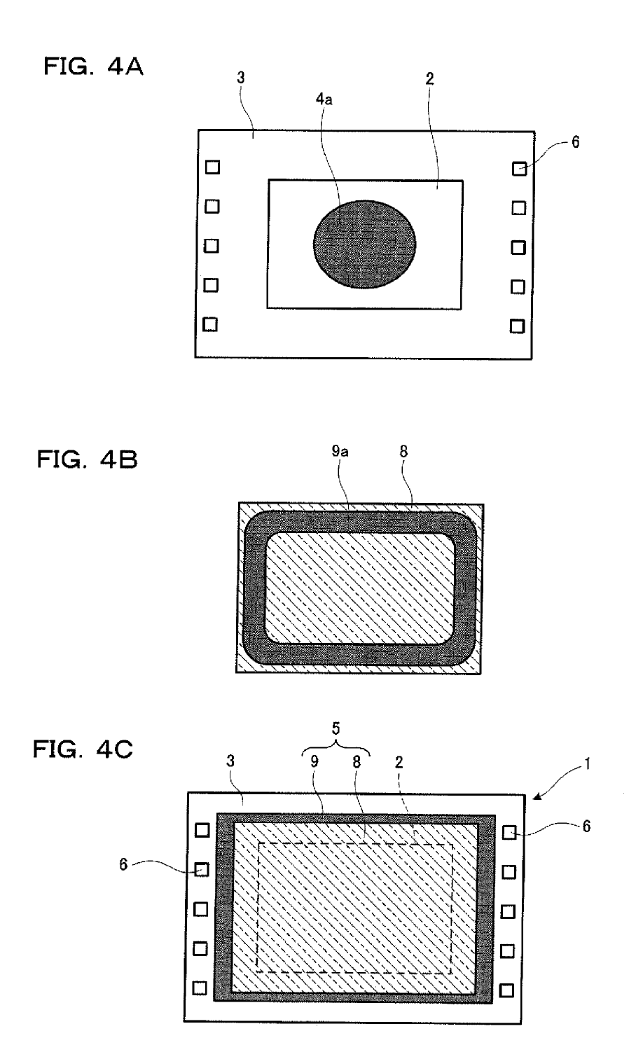

FIG. 4 shows a first example of a method of manufacturing the optical device 1. As shown in FIG. 4A, a resin adhesive 4a is applied to that position on the top surface of the optical element 3 which corresponds to a central portion (which is also a central portion of the light receiving portion 2) of a securing area (transparent member area) of the base material 8. On the other hand, as shown in FIG. 4B, a resin material 9a is coated on a peripheral portion of the base material 8.

Subsequently, as shown in FIG. 4C, the base material 8 is placed on the top surface of the optical element 3 and pressed against the top surface to spread the resin adhesive 4a between the base material 8 and the optical element 3 so that the resin adhesive 4a has a uniform thickness. This also allows the resin material 9a to stick out from the base material 8 to form a fillet between the outer side surface of the base material 8 and the top surface of the optical element 3. In this state, the resin adhesive 4a and the resin material 9a are hardened to secure the base material 8 on the top surface of the optical element 3 to obtain the resin portion 9.

When the base material 8 is pressed against the top surface of the optical element 3 as described above, the gap and parallelism between the base material 8 and the optical element 3 can be controlled by using a transfer collet or the like to maintain a predetermined posture. The resin material 9a may be and is desirably of the same type as that of the resin adhesive 4a.

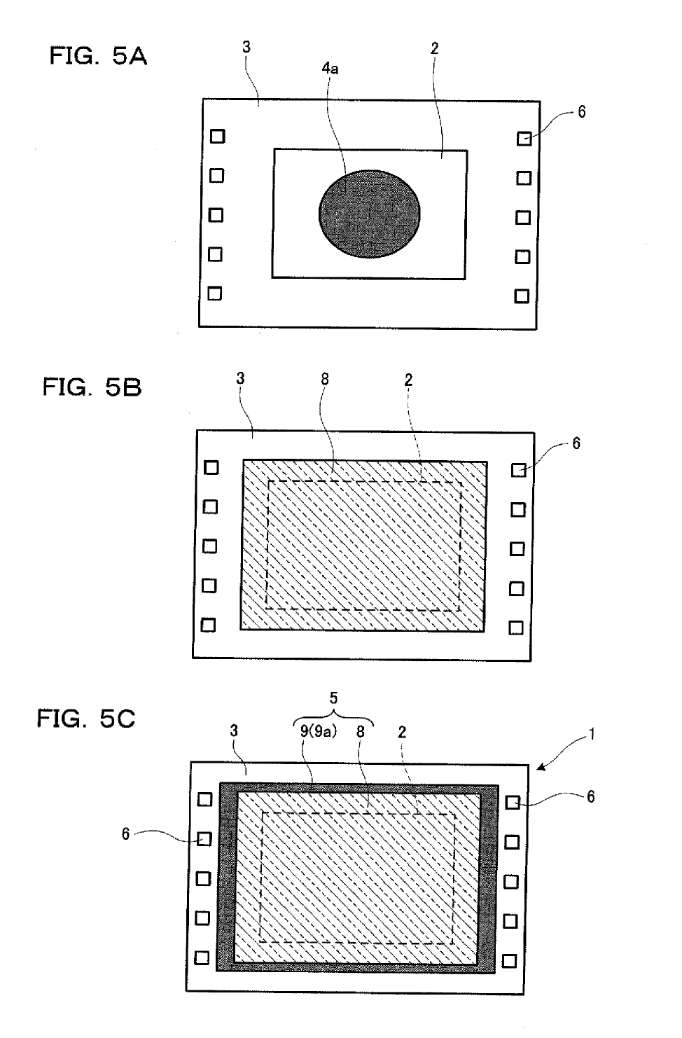

FIG. 5 shows a second example of a method of manufacturing the optical device 1. As shown in FIG. 5A, the resin adhesive 4a is applied to that position on the top surface of the optical element 3 which corresponds to the central portion of the securing area of the base material 8.

Then, as shown in FIG. 5B, the base material 8 is placed on the top surface of the optical element 3 using the transfer collet or the like. The base material 8 is then pressed against the top surface while maintaining a predetermined posture to spread the resin adhesive 4a between the base material 8 and the optical element 3 so that the resin adhesive 4a has a uniform thickness. In this state, the resin adhesive 4a is hardened to secure the base material 8 to the top surface of the optical element 3.

Subsequently, as shown in FIG. 5C, the resin material 9a is applied to the boundary portion between the outer side surfaces of the base material 8 and the top surface of the optical element 3 to form a fillet. In this state, the resin material 9a is hardened to obtain the resin portion 9.

This method allows the fillet shape to be controlled more accurately than the method shown in FIG. 2. The resin adhesive 4a between the base material 8 and the optical element 3 may be hardened simultaneously with the hardening of the resin material 9a. The resin material 9a may be and is desirably of the same type as that of the resin adhesive 4a.

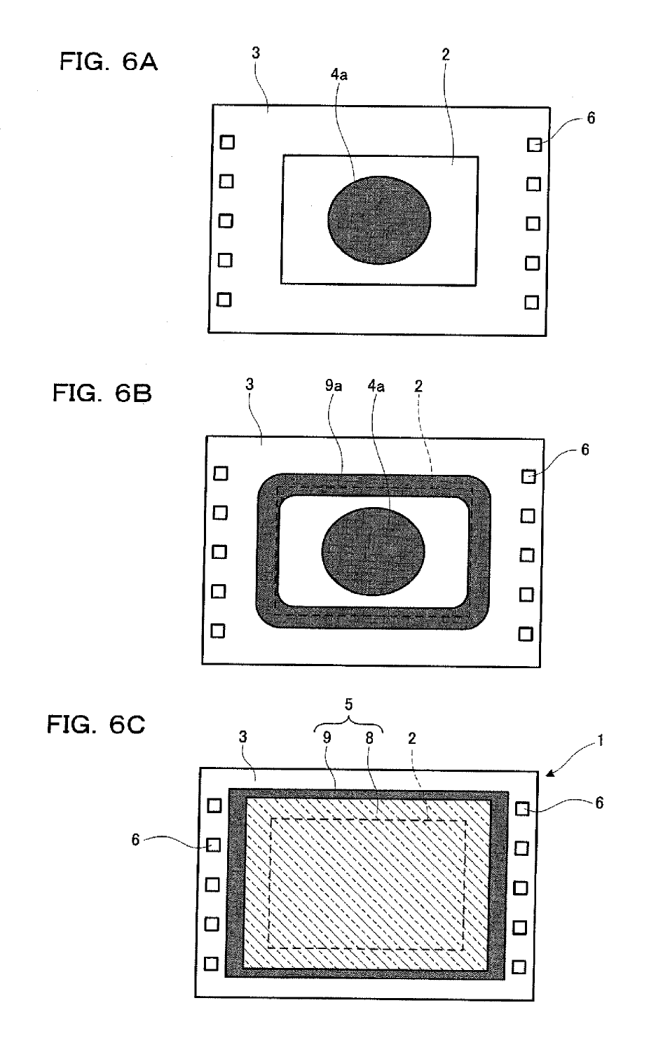

FIG. 6 shows a third example of a method of manufacturing the optical device 1. As shown in FIG. 6A, the resin adhesive 4a is applied to that position on the top surface of the optical element 3 which corresponds to the central portion of the securing area of the base material 8. Further, as shown in FIG. 6B, the resin material 9a is coated on the peripheral portion of the securing area of the base material 8.

Then, as shown in FIG. 6C, the base material 8 is placed on the top surface of the optical element 3 using the transfer collet or the like. The base material 8 is then pressed against the top surface while maintaining a predetermined posture to spread the resin adhesive 4a between the base material 8 and the optical element 3 so that the resin adhesive 4a has a uniform thickness. This also allows the resin material 9a to stick cut from the base material 8 to form a fillet between the outer side surfaces of the base material 8 and the top surface of the optical element 3. In this state, the resin adhesive 4a and the resin material 9a are hardened to secure the base material 8 to the top surface of the optical element 3, while obtaining the resin portion 9.

This method allows the fillet to be formed faster than the method shown in FIG. 5 and more easily than the method shown in FIG. 4. The resin material 9a may be and is desirably of the same type as that of the resin adhesive 4a.

Although not shown, it is possible to apply the resin adhesive 4a only to that position on the top surface of the optical element 3 which corresponds to the central portion of the securing area of the base material 8 so that the resin adhesive 4a secures the base material 8 to the top surface of the optical element 3, while forming the resin portion 9.

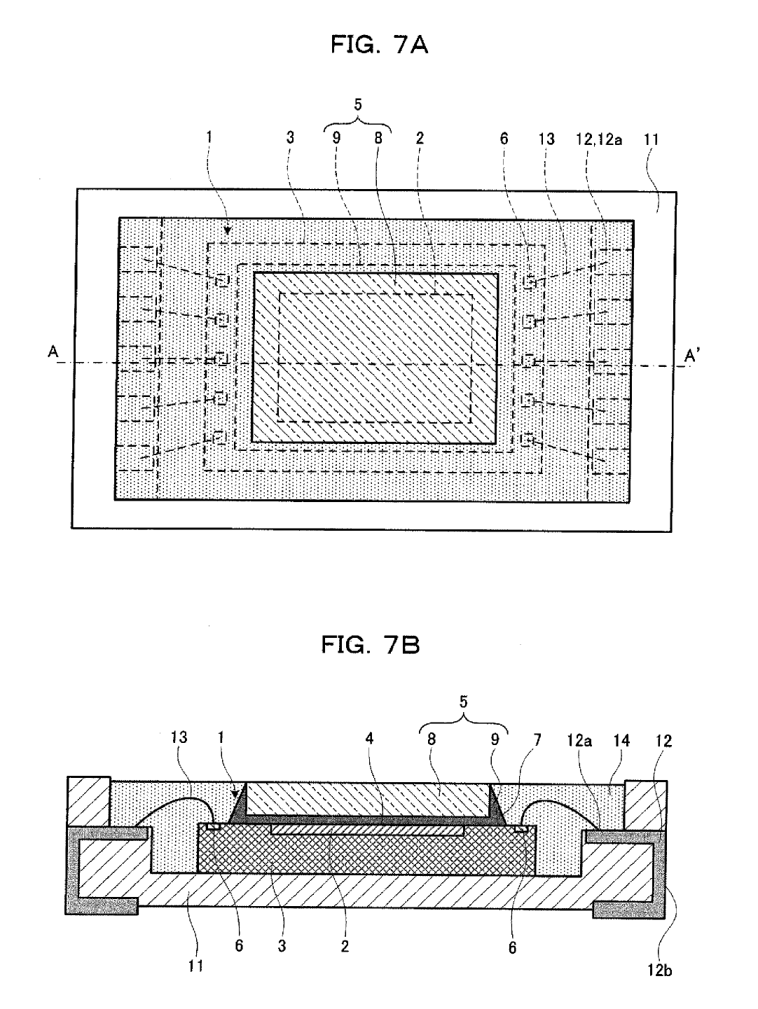

FIG. 7A is a plan view showing a first example in which the optical device 1 is packaged. FIG. 7B is a sectional view of the optical device taken along line A-A′ in FIG. 7A.

The optical device 1 is packaged using an optical element support composed of a recessed case 11 and a lead portion 12 extending from the inside to outside of the recess. That is, the optical device 1 (optical element 3 and transparent member 5) is housed in the recess of the case 11, and a bottom surface of the optical element 3 is secured to an inner bottom surface of the case 11. The electrode portions 6 on the top surface of the optical element 3 are electrically connected to internal terminals 12a of the lead portion 12 by wires 13. A sealing resin 14 is filled into the recess so as to form an opening on the transparent member 5.

Even in the structure in which the optical device 1 is thus housed in the recess of the case 11, the transparent member 5 has the inclined surface 7, described above. This eliminates the need to take into account the possible interference between the transparent member 5 and the capillary (not shown) for connection (wire bonding) of the wires 13. Thus, chip size may be the same as that in the prior art. That is, the optical element 3 need not be designed so as to provide a long distance between the light receiving portion 2 and the electrode portions 6. This enables a reduction in the size of the entire package and in costs.

The case 11 is formed of resin or ceramic, and the lead portion 12 is formed using a lead frame or the like. As is well known, the lead frame has at least a plurality of lead portions 12 and an outer frame portion (not shown because the outer frame portion has already been cut off) that holds the lead portions 12. Metal wires are used as the wires 13.

The sealing resin 14 is desirably filled so as to cover the entire outer peripheral surfaces of the transparent member 5, that is, the entire inclined surfaces 7, as shown in the figures. However, the sealing resin 14 may be filled so as to cover only a part of the outer peripheral surfaces. For example, the sealing resin 14 may be filled so as to cover only the outer peripheral surfaces located opposite the wires 13 (in order to prevent reflected light from the wires 13) or only the outer peripheral surfaces that are closer to the light receiving portion 2.

Any of an acrylic resin, an epoxy resin, a silicon resins and the like may be used as the sealing resin 14. The coating with the sealing resin 14 enables unwanted incident light and the like to be inhibited even if the light blocking process is omitted, which, for example, coats the light blocking resin on the outer peripheral surface of the transparent member 5. The light blocking resin further stabilizes the optical properties.

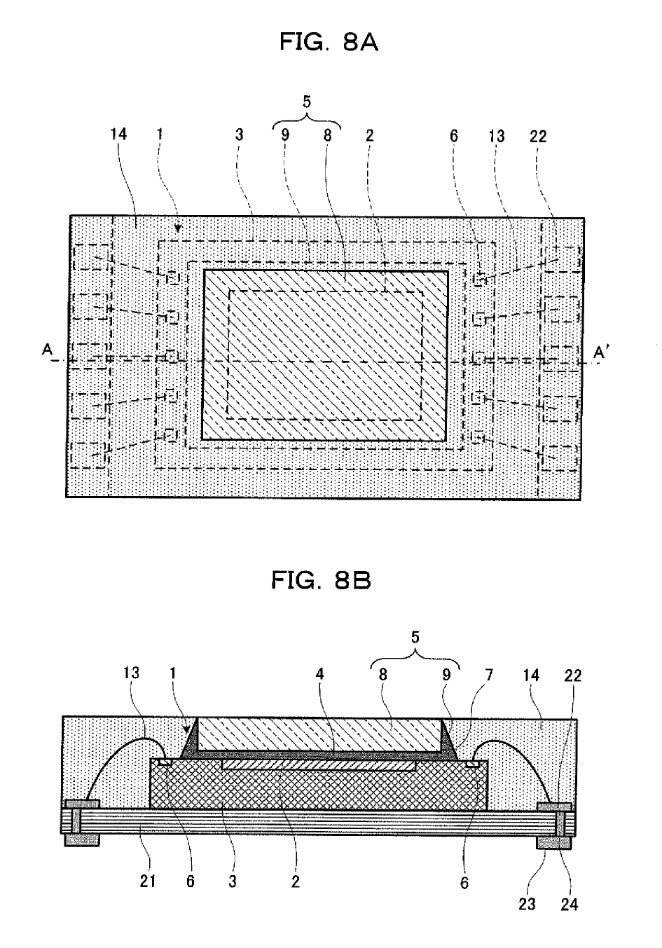

FIG. 8A is a plan view showing a second example in which the optical device 1 is packaged. FIG. BB is a sectional view of the optical device 1 taken along line A-A′ in FIG. 8A.

The optical device 1 is packaged using a circuit board 21. The circuit board 21 is a circuit into which a resin or ceramic as a base material is formed. The circuit board 21 has internal electrodes 22 formed on one of the opposite surfaces thereof and external electrodes 23 formed on the other surface, and vias 24 (which may be inner layer wires or the like) each electrically connecting the corresponding internal electrode 22 and external electrode 23. The bottom surface of the optical element 3 is secured to a predetermined position on the circuit board 21. The electrode portions 6 on the top surface of the optical element 3 are electrically connected to the respective internal electrodes 22 on the circuit board 21 by the wires 13. The circuit board 21 and the optical element 3 are sealed with the sealing resin 14 so as to form an opening on the transparent member 5.

In this structure, the transparent member 5 has the inclined surface 7, and no sidewall such as the one provided in the case 11 is present. This eliminates the need to take into account the possible interference between the transparent member 5 and the capillary (not shown) for connection (wire bonding) with the wires 13. This in turn enables a reduction in the size of the entire package and in costs.

Packaging may be carried out using a lead frame instead of the circuit board 21. The circuit board 21 or the lead frame enables diversified, general-purpose package forms to be obtained, allowing a reduction in costs.

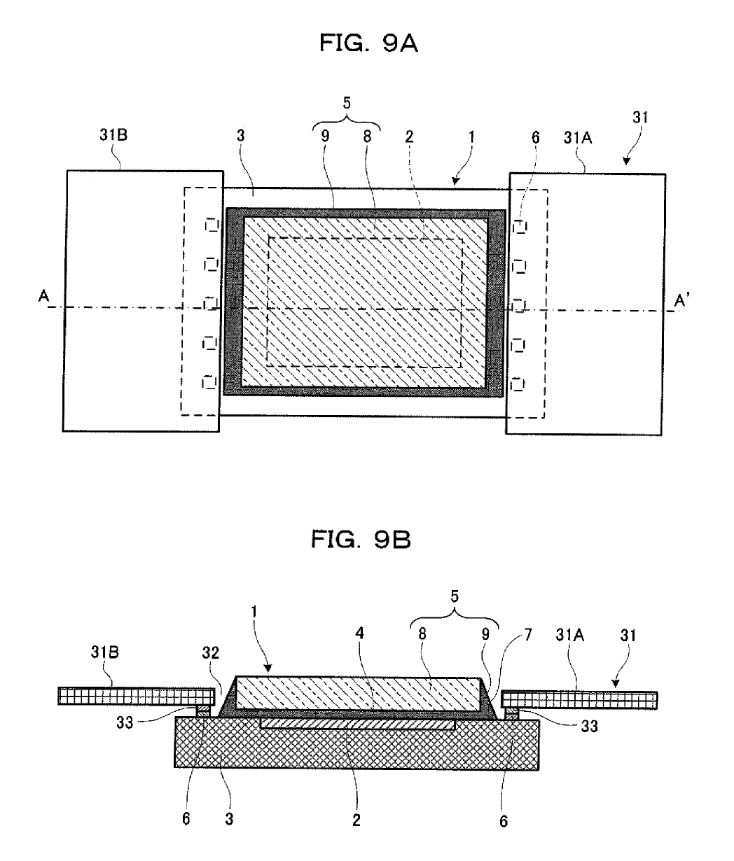

FIG. 9A is a plan view showing a third example in which the optical device 1 is packaged. FIG. 9B is a sectional view of the optical device 1 taken along line A-A′ in FIG. 9A.

A circuit board 31 (31A and 31B) has a circuit into which a resin or ceramic as a base material is formed. Each of the circuit boards 31A and 31B has wires (not shown) formed thereon and having internal electrodes 33 arranged opposite the respective electrode portions 6 on the optical element 3. An open portion 32 is formed between the circuit boards 31A and 31B in association with the transparent member 5. In the optical device 1, with the transparent member 5 positioned in the open portion 32 of the circuit board 31, the electrode portions 6 are connected directly to the respective internal electrodes 33. Although not shown, the connections between the internal electrodes 33 and the electrode portions 6 are sealed with the sealing resin.

In this structure, the transparent member 5 is placed in the open portion 32 of the circuit board 31. This not only enables a reduction in thickness but also allows the open portion 32 to be designed to be smaller because of the inclined surface 7 of the transparent member 5. Thus, the size and thickness of the mounting portion can be reduced. The costs can also be reduced. Instead of the two-piece circuit board 31, a frame-shaped circuit board with an opening can produce similar effects.

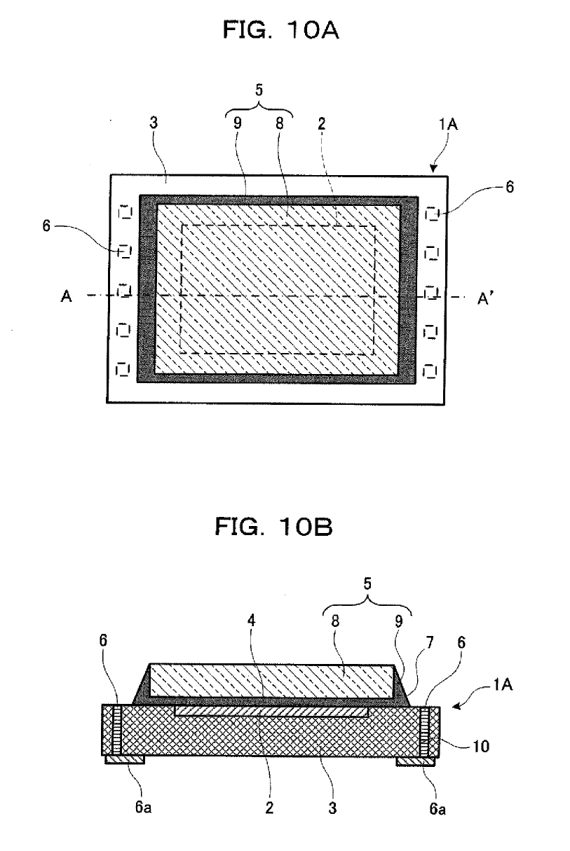

FIG. 10A is a plan view of an optical device in accordance with a second embodiment of the present invention. FIG. 10B is a sectional view of the optical device taken along line A-A′ in FIG. 10A.

The optical device 1A is different from the optical device 1 in that vias 10 electrically connected to the light receiving portion 2 are formed in the peripheral portion of the optical element 3, which is not covered with the transparent member 5, and in that one end of each of the vias 10 is formed into the electrode portion 6, with a projecting electrode 6a formed at the other end of the via 10. This structure makes it possible to provide a multi-pin structure and to reduce the size and thickness of the optical device 1A.

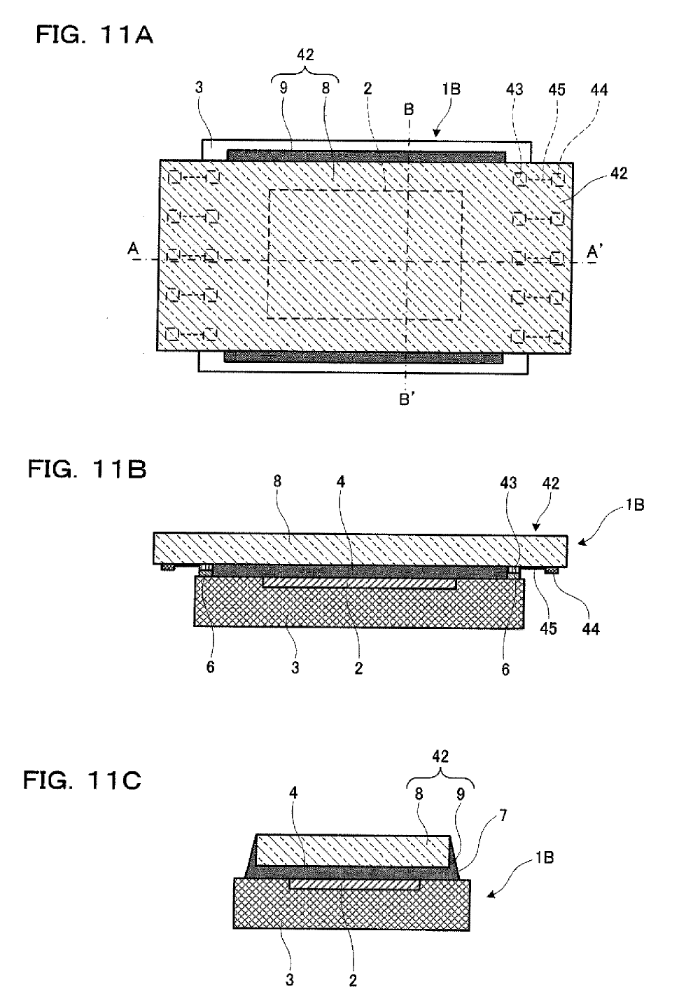

FIG. 11A is a plan view of an optical device in accordance with a third embodiment of the present invention. FIG. 11B is a sectional view of the optical device taken along line A-A′ in FIG. 11A. FIG. 11C is a sectional view of the optical device taken along line B-B′ in FIG. 11A.

The optical device 1B is different from the optical device 1 in that the optical device 1B has a transparent member 42 instead of the transparent member 5, described above. A transparent member 42 is made of the rectangular plate-shaped base material 8 secured to the top surface of the optical element 3, and the resin portion 9 forming a fillet between each of two opposite outer side surfaces of the base material 8 and the top surface of the optical element 3. Only the two outer peripheral surfaces composed of the resin portion 3 are each the inclined surface 7. The base material 8 is sized so that the two ends of the base material 8 on which the resin portion 9 is not formed project out from the optical element 3. The base material 8 has wires 45 formed thereon and each having an internal electrode 43 located opposite the corresponding electrode portion 6 on the top surface of the optical element 3 and an external connection electrode 44 positioned outside the optical element 3. The projecting electrode portions 6 of the optical element 3 are connected directly to the respective internal electrodes 43 of the transparent member 42. This structure enables a reduction in the size and thickness of the optical device 1B.

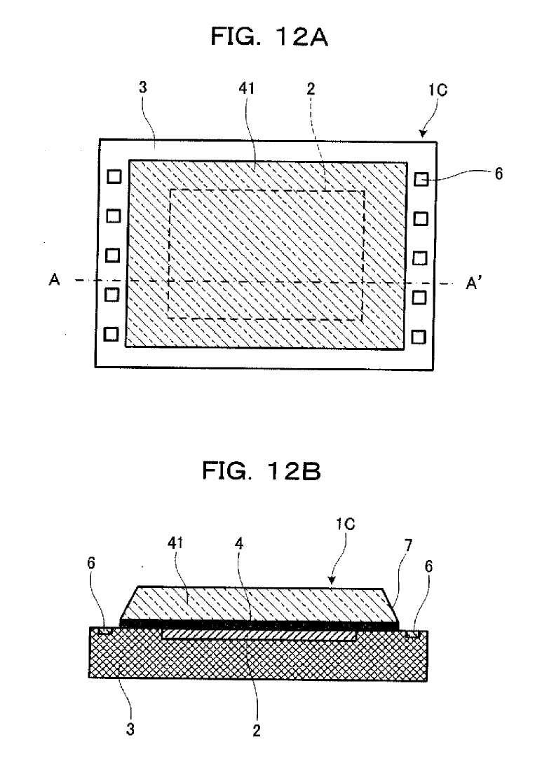

In an optical device 1C shown in FIGS. 12A and 12B, instead of the transparent member 5, a transparent member 41 shaped similarly to the transparent member 5 and made of a single material (the same as the base material 8) is secured to the top surface of the optical element 3. The remaining part of the structure of the optical device 1C is similar to that of the optical device 1 in FIG. 1.

Obviously, the transparent member 41 can exert such effects as described for the transparent member 5. That is, the transparent member 41 inhibits unwanted incident light from the outside of the inclined surface 7 from reaching the light receiving portion 2. The transparent member 41 also inhibits unwanted incident light from the inside of the inclined surface 7 from reaching the light receiving portion 2 as reflected light.

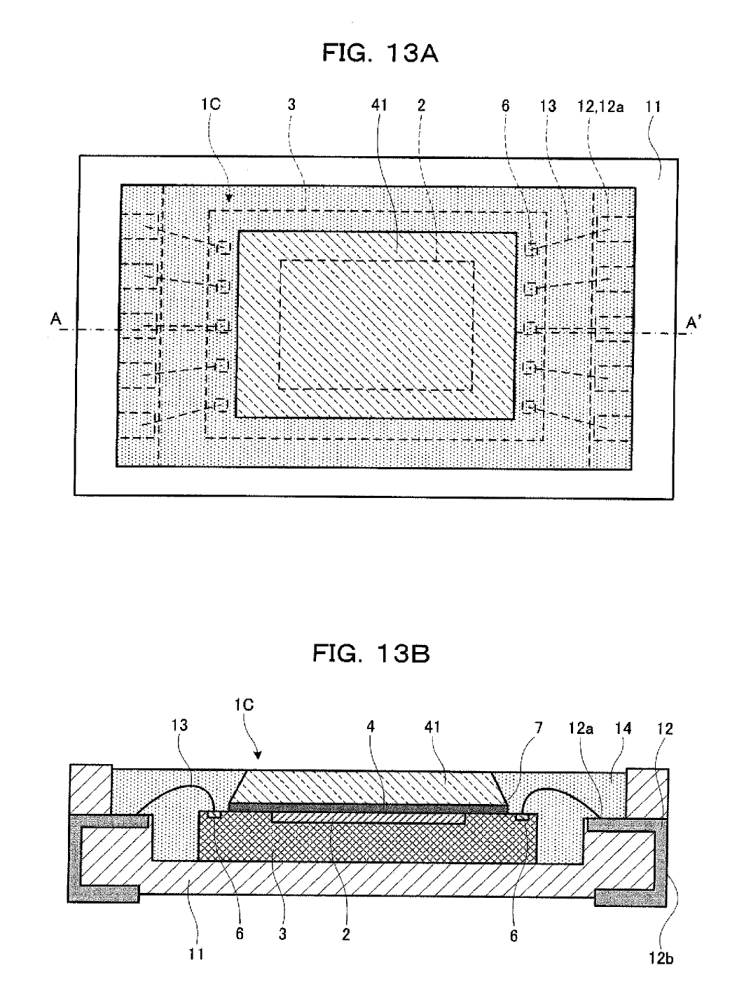

FIG. 13A is a plan view showing a first example in which the optical device 1C is packaged. FIG. 13B is a sectional view of the optical device 1C taken along line A-A′ in FIG. 13A. The configuration in FIGS. 13A and 13B is similar to that in FIGS. 7A and 7B except that the former uses the optical device 1C.

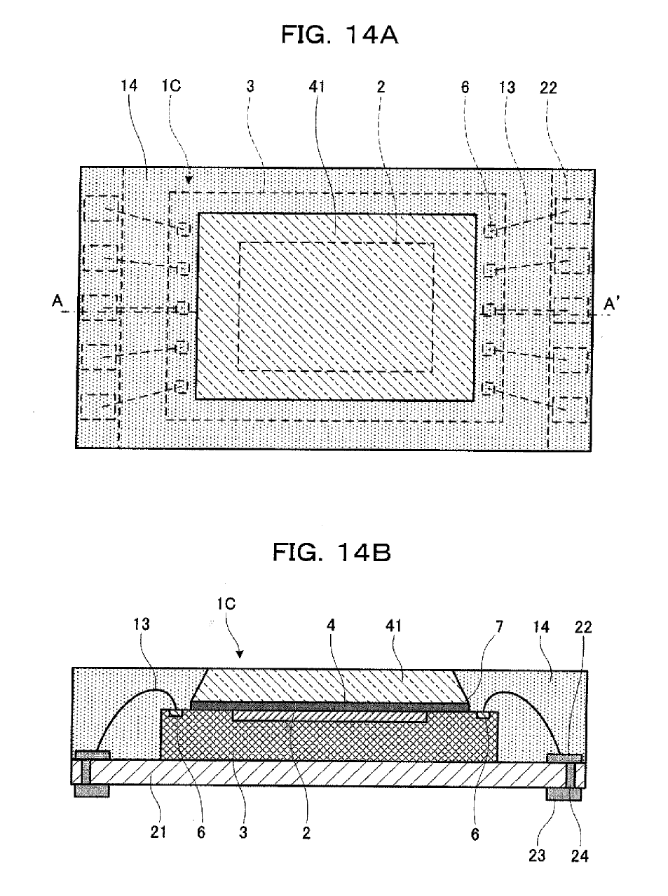

FIG. 14A is a plan view showing a second example in which the optical device 1C is packaged. FIG. 14B is a sectional view of the optical device 1C taken along line A-A′ in FIG. 14A. The configuration in FIGS. 14A and 14B is similar to that in FIGS. 8A and 8B except that the former uses the optical device 1C.

As described above, according to the present invention, in the optical device having the transparent member secured directly on the optical element, the transparent member is provided with the inclined surface on the outer periphery thereof utilizing the resin fillet. This makes it possible to prevent unwanted incident light and reflected light from entering the light receiving portion, enabling a reduction in the size and cost of the optical device itself. The optical device is particularly useful for small-sized electronic apparatuses.

What is claimed is:

1. An optical device having an optical element with a light receiving portion formed on a top surface thereof and a transparent member covering the light receiving portion, the transparent member comprising a base material secured to the top surface of the optical element and a resin portion forming a fillet between outer side surfaces of the base material and the top surface of the optical element.

2. The optical device according to claim 1, wherein an adhesive used to secure the base material on the optical element and the resin portion comprise the same transparent resin material.

3. The optical device according to claim 1, wherein the resin portion is covered with a light blocking resin.

4. The optical device according to claim 1, wherein the optical element has electrode portions formed on at least one of the top and bottom surfaces.

5. The optical device according to claim 4, wherein the optical element has the electrode portions formed at appropriate positions on a part of the top surface which is not covered with the transparent member, and is connected, at the electrode portions, to internal terminals of conductors via metal wires and sealed with a sealing resin so as to have an opening on the transparent member.

6. The optical device according to claim 4, wherein the optical element has projecting electrode portions formed at appropriate positions on a part of the top surface which is not covered with the transparent member, and is connected, at the electrode portions, directly to electrodes formed on a circuit board opposite the respective electrode portions, the circuit board having an opening corresponding to the transparent member.

7. The optical device according to claim 4, wherein the optical element has the projecting electrode portions formed at appropriate positions on a part of the top surface which is covered with the transparent member, the transparent member has wires formed on a base material thereof and having electrodes arranged opposite the electrode portions, and the electrode portions of the optical element are connected directly to the electrodes on the transparent member.

8. The optical device according to claim 5, wherein the sealing resin has a property of blocking light.

9. A method of manufacturing the optical device according to claim 1, the method comprising:
a step of coating a first transparent resin material on a central portion of a transparent member area of a top surface of an optical element;
a step of coating a second transparent resin material on a peripheral portion of a base material; and
a step of mounting and securing the base material on the top surface of the optical element using the first and second transparent resin materials, and forming a fillet comprising the second transparent resin material between the top surface of the optical element and each outer side surface of the base material.

10. A method of manufacturing the optical device according to claim 1, the method comprising:
a step of coating a first transparent resin material on a central portion of a transparent member area of a top surface of an optical element;
a step of mounting and securing a base material on the top surface of the optical element using the first transparent resin material; and
a step of coating a second transparent resin material on outer side surfaces of the base material secured on the top surface of the optical element to form a fillet comprising the second transparent resin material between the top surface of the optical element and each of the outer side surfaces of the base material.

11. A method of manufacturing the optical device according to claim 1, the method comprising:
a step of coating a first transparent resin material and a second transparent resin material on a central portion and a peripheral portion of a transparent member area of a top surface of an optical element; and
a step of mounting and securing a base material on the top surface of the optical element using the first and second transparent resin materials, and forming a fillet comprising the second transparent resin material between the top surface of the optical element and each outer side surface of the base material.

12. A method of manufacturing the optical device according to claim 1, the method comprising:
a step of coating a transparent resin material on a central portion of a transparent member area of a top surface of an optical element; and
a step of mounting and securing a base material on the top surface of the optical element using the transparent resin materials, and forming a fillet comprising the transparent resin material between the top surface of the optical element and each outer side surface of the base material.
